(19) United States
(12) Patent Application Publication
(10) Pub. No.: US 2006/0253802 A1
(43) Pub. Date: Nov. 9, 2006

(54) Electronic device and control method thereof

(75) Inventor: Joon-Hwan Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/325,353

(22) Filed: Jan. 5, 2006

(30) Foreign Application Priority Data
May 3, 2005 (KR) 2005-0037115

(51) Int. Cl. G06F 9/00

(52) U.S. Cl. 715/836; 715/848; 715/849; 715/852; 715/841

(57) ABSTRACT

The present invention relates to an electronic device having a GUI generator capable of processing a GUI including at least one item in three dimensions. Further, the present invention includes a user selection part to allow a user to indicate or select the item; a controller to control the GUI generator to process and generate the GUI in two dimensions when a GUI function is selected through the user selection part, and process and generate the item indicated through the user selection part in three dimensions. Thus, the present invention provides an electronic device and a control method thereof, in which an indicated or selected item of a GUI is processed and generated in three dimensions, thereby allowing a user to effectively distinguish the indicated or selected item from the other items.

### CROSS-REFERENCE TO RELATED APPLICATIONS

This application claims priority from Korean Patent Application No. 2005-0037115, filed May 3, 2005, in the Korean Intellectual Property Office, the disclosure of which is incorporated herein by reference.

### BACKGROUND OF THE INVENTION

1. Field of the Invention

Apparatuses and methods consistent with the present invention relate to generating a graphic user interface (GUI) including at least one item in three-dimension.

2. Description of the Related Art

A general electronic device including a display device like a television and a monitor, or a digital video disk (DVD) player, etc., which displays or reproduces a picture and a sound, displays a GUI including various items for allowing a user to adjust a state thereof or to select data.

Accordingly, various methods for allowing a user to easily recognize the GUI have recently been applied to the electronic device. As exemplary methods, the size, the color or the brightness of an indicated item may be adjusted so that a user can easily distinguish the indicated item from non-indicated items. Further, the display tone of the indicated item can be lowered, and thus the background and the GUI are displayed overlapping with each other, which is called a halftone method.

However, all of these methods process the GUI in two dimensions, so that there is a limit to allow a user to visually distinguish an indicated or selected item from the other items.

### SUMMARY OF THE INVENTION

Accordingly, it is an aspect of the present invention to provide an electronic device and a control method thereof, in which an indicated or selected item of a GUI is processed and generated in three dimensions, thereby allowing a user to effectively distinguish the indicated or selected item from the other items.

Additional aspects and/or advantages of the invention will be set forth in part in the description which follows and, in part, will be obvious from the description thereof.

The foregoing and/or other aspects of the present invention are achieved by providing an electronic device comprising a GUI generator capable of processing a GUI including at least one item in three dimensions; a user selection part to allow a user to indicate or select the item; and a controller to control the GUI generator to process and generate the GUI in two dimensions when a GUI function is selected through the user selection part, and process and generate the item indicated through the user selection part in three dimensions.

According to an aspect of the present invention, the controller controls the GUI generator to move the indicated item in a virtual axis by a predetermined distance, and process and generate the indicated item along with a moving trajectory in three dimensions.

According to an aspect of the present invention, the controller controls the GUI generator to move the indicated item to move by a predetermined distance in a (+) direction of the virtual axis.

According to an aspect of the present invention, the controller controls the GUI generator to move the indicated item to move by a predetermined distance in a (−) direction of the virtual axis.

According to an aspect of the present invention, the controller controls the GUI generator to move the indicated item to move by a predetermined distance in (+) and (−) directions of the virtual axis.

According to an aspect of the present invention, the controller controls the GUI generator to process and generate a sub-menu including a plurality of sub-items corresponding to the indicated item in two dimensions when the indicated item is selected through the user selection part.

According to an aspect of the present invention, the controller controls the GUI generator to process and generate a sub-menu including a plurality of sub-items corresponding to the indicated item on the same plane as one plane of the item displayed in three dimensions when the indicated item is selected through the user selection part.

According to an aspect of the present invention, the controller controls the GUI generator to process and generate a sub-menu including a plurality of sub-items corresponding to the indicated item on a plane moved by a shorter distance than the predetermined distance along the virtual axis in three dimensions when the indicated item is selected through the user selection part.

According to an aspect of the present invention, the controller controls the GUI generator to process and generate the sub-item in three dimensions when the sub-item of the sub-menu is indicated through the user selection part, and performs a function corresponding to the indicated sub-item when the indicated sub-item is selected.

According to an aspect of the present invention, the controller controls the GUI generator to move the indicated sub-item by a predetermined distance in the virtual axis, and process and generate the indicated item along with a moving trajectory in three dimensions.

According to an aspect of the present invention, the controller controls the GUI generator to further move the indicated sub-item by a predetermined distance in the virtual axis than the item generated in the three dimensions.

According to an aspect of the present invention, the sub-items of the sub-menu comprises video/audio items to control video and audio modes; a size item to control a display size of a picture; a language item to control language; an input item to control an input video source; and an auto-program item to search provided channels.

According to an aspect of the present invention, the controller controls the GUI generator to change at least one of the brightness, the color and the size of the indicated item.

The foregoing and/or other aspects of the present invention are achieved by providing a method of controlling an electronic device comprising a GUI generator to generate a GUI including at least one item, the method comprising processing and generating the GUI in two dimensions when a GUI function is selected through a user selection part; and processing and generating the item indicated through the user selection part in three dimensions.

According to an aspect of the present invention, the processing and generating the indicated item in three dimensions comprises moving the indicated item in a virtual axis by a predetermined distance, and processing and generating the indicated item along with a moving trajectory in three dimensions.

According to an aspect of the present invention, the method further comprises processing and generating a sub-menu including a plurality of sub-items corresponding to the indicated item on the same plane as one plane of the item displayed in three dimensions when the indicated item is selected through the user selection part.

According to an aspect of the present invention, the method further comprises processing and generating the sub-item in three dimensions when the sub-item is indicated on the sub-menu, and performing a function corresponding to the indicated sub-item when the indicated sub-item is selected.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a control block diagram of a television according to an exemplary embodiment of the present invention;

FIG. 2 is a control flowchart of the television according to an exemplary embodiment of the present invention; and

FIGS. 3A through 3D shows a GUI displayed on a display part according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to like elements throughout. The embodiments are described below so as to explain the present invention by referring to the Figures

Hereinafter, a television will be exemplary described as an electronic device of the present invention.

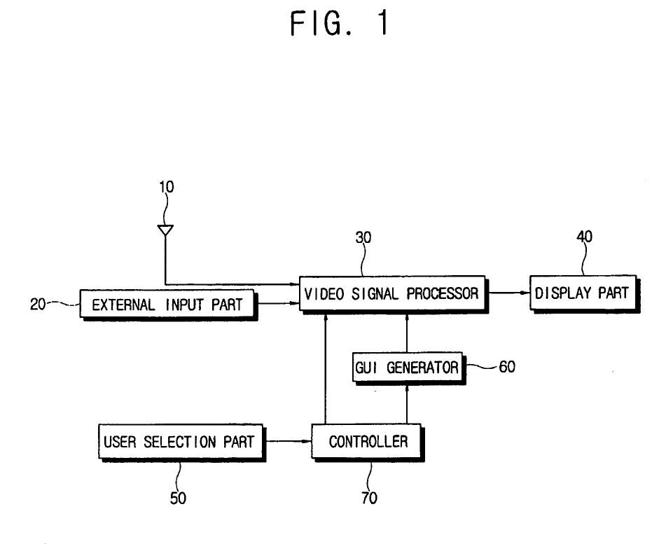

FIG. 1 is a control block diagram of a television according to an exemplary embodiment of the present invention.

As shown in FIG. 1, a television according to an exemplary embodiment of the present invention includes an antenna 10, an external input part 20, a video signal processor 30, a display part 40, a user selection part 50, and a controller 70.

The video signal processor 30 receives a video signal through the antenna 10 and the external input part 20, and processes the video signal to be displayable on the display part 40. Here, the external input part 20 includes an analog connection terminal to receive an analog video signal such as a composite video baseband signal (CVBS), an S-video signal or the like, and a digital connection terminal to receive a digital video signal such as a digital video interface (DVI) signal or the like.

The video signal processor 30 includes a tuner for selecting a radio frequency (RF) signal such as a broadcasting signal received through the antenna 10; and a video decoder for decoding the analog video signal such as the CVBS, the S-video signal or the like received from the external input part 20 and the broadcasting signal selected by the tuner.

Further, the video signal processor 30 may include a transition minimized differential signaling (TMDS) receiver dividing the digital video signal such as the DVI signal received through the digital connection terminal into red, green and blue (RGB) signals and horizontal/vertical (H/V) synchronization signals; and an analog/digital (A/D) converter converting the analog video signal such as a component signal, a personal computer (PC) signal, etc. into the digital video signal. Also, the video signal processor 30 may include a scaler and a frame buffer, which process the video signals converted by the video decoder and the A/D converter to be displayable on the display part 40.

Here, the video signal processor 30 mixes and outputs the processed video signal with a GUI signal corresponding to a GUI generated by a GUI generator 60.

The display part 40 receives the video signal and the GUI signal from the video signal processor 30, and displays a picture based on the video signal and the GUI signal. The display part 40 includes a display panel on which a picture is displayed, and a panel driver.

The user selection part 50 outputs a key signal to the controller 70 according to manipulations of a user. Here, the user selection part 50 is placed in the television and includes a menu key for allowing a user to select a user control function; direction keys (e.g., up, down, left and right keys) for indicating or selecting items of the GUI; and a key signal generator for generating key signals corresponding to key manipulations. Alternatively, the user selection part 50 may be provided as a separate input means such as a mouse, a keyboard, etc., which is connected to the television, or a remote controller. When a user manipulates a button or a key, the key signal generator generates the key signal corresponding to the key manipulations, and outputs the key signal to the controller 70. Thus, the controller 70 controls the video signal processor 30, the GUI generator 60, etc. on the basis of the key signal output from the key signal generator.

The GUI generator 60 generates a user control menu, which includes at least one item for controlling an input/output setting for a sound and a picture of the television, and a sub-menu corresponding to each item. Here, the GUI generator 60 may include an on screen display (OSD) generator to display an OSD. Further, the GUI generator 60 may include a three-dimensional graphic engine capable of processing a picture in three dimensions, and a corresponding program.

The GUI generator 60 is controlled by the controller 70 to process and generate the GUI signal corresponding to the user control menu in two dimensions (2D). Further, the GUI generator 60 moves an indicating highlight as the user selection part 50 is manipulated, and processes and generates item data corresponding to the indicated or selected items in three dimensions (3D).

While the GUI generator 60 is controlled by the controller 70 to process and generate the item data corresponding to the item in three dimensions, the GUI generator 60 models a geometrical graphic of the item in a 3D-coordinate system; projects the three-dimensional graphic on a 2D-plane; and performs color and gradation rendering processes for the generated 3D-graphic. Here, the rendering process gives a three-dimensional texture such as shade or gradation to the graphic, thereby enhancing reality. For example, the rendering process includes a hidden surface removal process, a shading process, a texture mapping process, etc.

At this time, the shape, the size, the color, the brightness and the position of the 3D-processed item can be variously designed. Thus, the item indicated by a user can be distinguished by the coordinates, the size and the color thereof.

Alternatively, the GUI generator may process the GUI signal in two dimensions in order to achieve a 3D-effect.

Below, the user control menu processed and generated by the GUI generator 60 and its displaying operation will be described in more detail.

According to an exemplary embodiment of the present invention, the user control menu of the television includes items such as Picture, Sound, Channel, Time, Picture-In-Picture (PIP), Guide, etc. The picture item can include sub-items such as Mode, Size, Custom, etc. The sound item can include sub-items such as Mode, Custom, Mono/Stereo/SAP (MTS), etc. The channel item can include sub-items such as Auto Setup, Add/Delete, Favorite, etc. The Time item can include sub-items such as Clock, On timer, Off timer, etc. The PIP item can include sub-items such as On/Off, Size, Position, etc. The setup item can include sub-items such as Caption, etc.

Further, the user control menu may include a language item to select language, an input item to select an input video source, and an auto-program item to automatically search provided channels.

Meanwhile, when the present invention is applied, for example, to an electronic device such as a DVD player, the user control menu displayed as the GUI may include items such as Aspect Ratio, Dolby Digital, Disc Setup, Channel setup, Lock, Clock, Speaker Setup, etc. Additionally, the user control menu may include various items to display and select items related to other data.

Thus, the GUI signals corresponding to the user control menu and its sub-menu generated by the GUI generator 60 are mixed with the video signal output from the video signal processor 30.

When the user control function is selected through the menu key of the user selection part 50, the controller 70 controls the GUI generator 60 to process the user control menu in two dimensions. Then, the controller 70 controls the GUI generator 60 to indicate the item according as the up, down, left and right keys are manipulated through the user selection part 50, and controls the GUI generator 60 to process and generate the selected item in three dimensions. Here, the controller 70 may be achieved by a controller such as a microcomputer.

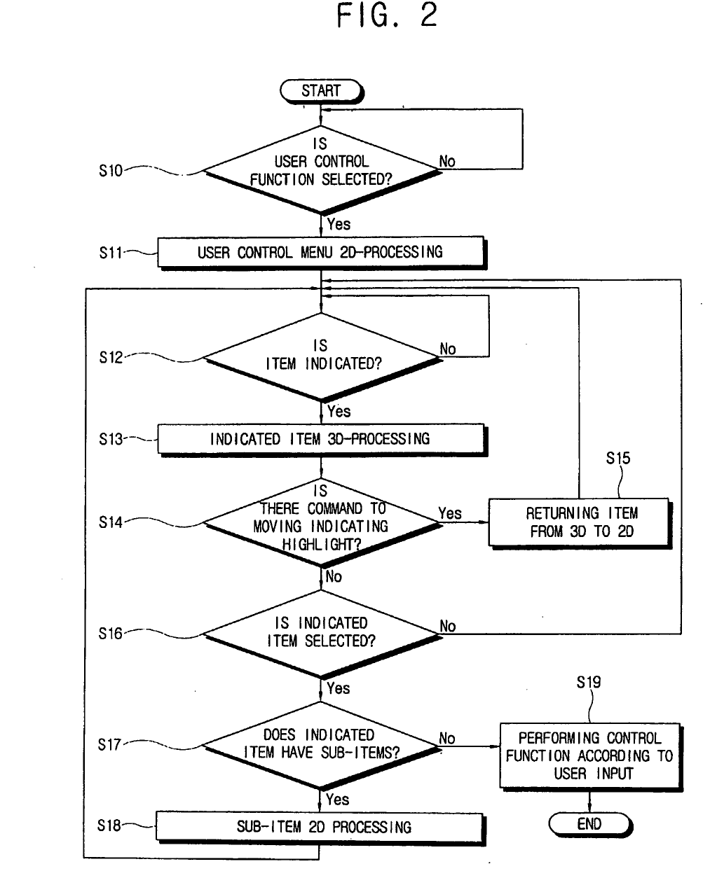

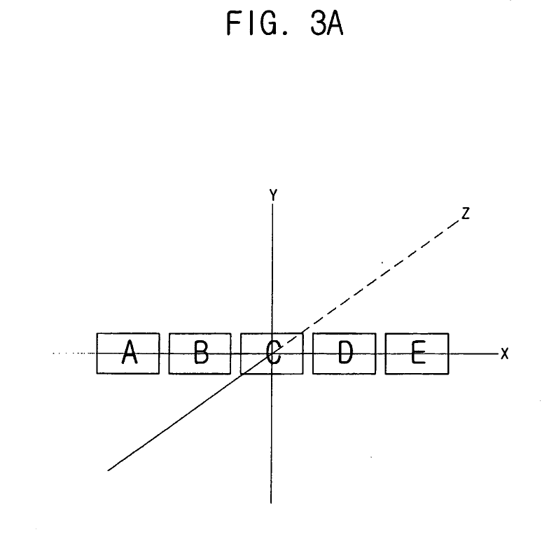

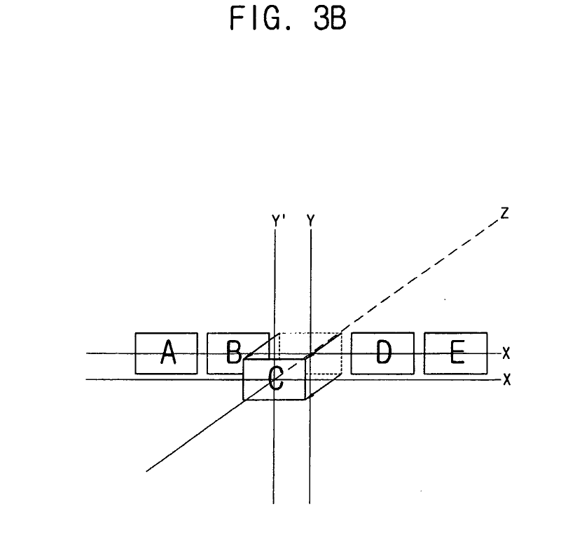

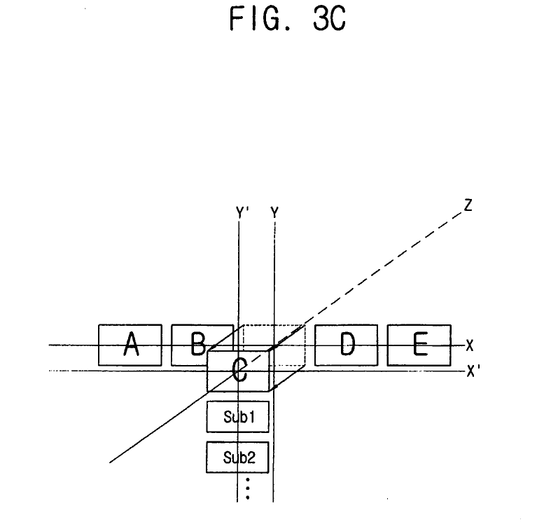

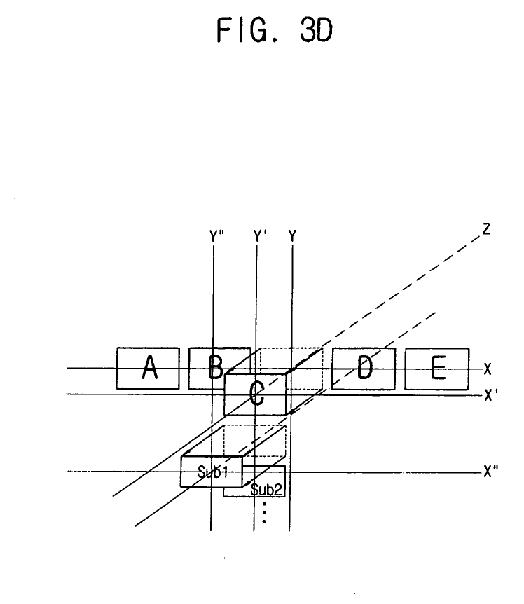

Below, a control method for controlling the television according to an exemplary embodiment of the present invention will be described with reference to FIG. 2 and FIGS. 3A through 3D. Here, repetitive descriptions will be avoided as necessary.

When a key for a user control function is selected through the user selection part 50 at operation S10, the controller 70 receives a key signal corresponding to the selected key and controls the GUI generator 60 to process and generate the GUI signal corresponding to the user control function in two dimensions at operation S11. At this time, the GUI for the user control function is mixed with the video signal currently processed by the television, and output to the display part 40, so that the display part 40 displays a picture based on the video signal, overlapping with the user control menu. As shown in FIG. 3A, the control items “A”, “B”, “C”, “D” and “E” are displayed in two dimensions on the display part 40, i.e., in coordinates on an X-axis and a Y-axis. The items, generated by the GUI generator 60 on the basis of a previously programmed command, are displayed in a predetermined region on the display part 40.

Further, when a user manipulates the up, down, left and right keys of the user selection part 50, the controller 70 controls the GUI generator 60 to move the indicating highlight corresponding to the corresponding key signal. When a predetermined item is indicated by the indicating highlight at operation S12, the controller 70 controls the GUI generator 60 to process and generate the indicated item in three dimensions at operation S13. As mentioned above, the shape, the size, the color, the brightness and the position of the 3D-processed item can be variously designed. FIG. 3B shows the indicated item by way of example. Referring to FIG. 3B, when a “C” item is indicated among rectangular items, the “C” item moves by a predetermined distance in a (+) direction of a Z-axis, so that a predetermined volume is formed along a moving trajectory, thereby displaying the “C” item in three dimensions. Alternatively, the “C” item may move in a (−) direction of the Z-axis. Thus, the front of the “C” item is positioned with respect to an X′-axis and a Y′-axis. Further, the indicated “C” item can move in the (+) direction and the (−) direction of the Z-axis.

At operation S14, the controller 70 determines whether a user manipulates the up, down, left and right keys through the user selection part 50, i.e., whether the user selection part 50 outputs a corresponding key signal. When the user selection part 50 outputs the corresponding key signal, the controller 70 receives the corresponding key signal and controls the GUI generator 60 to move the indicating highlight. When the indicating highlight is moved, the controller 70 controls the GUI generator 60 to return the three-dimensional item to the two-dimensional item at operation S15. Besides, when other items are newly indicated at the operation S12, the indicated item are processed and displayed in three dimensions at operation S13.

Further, when a user selects the indicated item through the user selection part 50 at operation S16, the controller 70 determines whether the selected item has sub-menus at operation S17.

When the selected item has the sub-menus, the controller 70 controls the GUI generator 60 to process and generate the sub-menus corresponding to the selected item in two dimensions at operation S18. As shown in FIG. 3C, sub-items “Sub1”, “Sub2”, . . . corresponding to the “C” item are displayed on the display part 40. At this time, the sub-items are displayed on the same plane as the front among the planes of the “C” item displayed in three dimensions, e.g., on the plane of the X′-axis and the Y′-axis. Alternatively, contrary to FIG. 3C, the sub-items may be displayed on the plane of the X-axis and the Y-axis. Further, the sub-items may be displayed in three dimensions, by moving to coordinates shorter than the coordinates of the X′-axis and the Y′-axis in the (+) directions thereof. Besides, the sub-items may be variously displayed.

When the selected item has no sub-items, the controller 70 controls the user control function to be implemented according to the selection or the input of a user at operation S19.

Further, when a user indicates one of the sub-items through the user selection part 50 at operation S12, the controller 70 controls the GUI generator 60 to process and generate the indicated sub-items in three dimensions at operation S13. Referring to FIG. 3D, the indicated sub-item “Sub1” moves by a predetermined distance in the (+) direction of the Z-axis, and positioned on the X″-axis and the Y″-axis, so that the “Sub1” item is displayed in three dimensions along a moving trajectory.

Here, the control loop shown in FIG. 2 is continuously repeated as much as each sub-item has its sub-items. Correspondingly, the X-axis and the Y-axis for displaying the items may be generated infinitely.

Alternatively, the indicated “Sub1” sub-item may move from the plane of the X′-axis and the Y′-axis in the (−) direction of the Z-axis by a predetermined distance.

In the foregoing embodiment, the television is illustrated as an example of the electronic device, but the present invention is not limited thereto. Alternatively, the present invention can be applied to various electronic devices including the DVD player that includes the ability to display the GUI. In the case of the DVD player, the GUI is displayed on a display apparatus, and the controller 70 of the DVD player controls the GUI generator 60 to process and display the GUI in two or three dimensions according to input signals of the user selection part 50.

In the foregoing exemplary embodiment, the user control menu is illustrated as an example of the GUI, but not limited to. Alternatively, the present invention can be applied to various GUIs as long as they display items related to other data and allow a user to select the items.

As described above, the present invention provides an electronic device and a control method thereof, in which an indicated or selected item of a GUI is processed and generated in three dimensions, thereby allowing a user to effectively distinguish the indicated or selected item from the other items.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An electronic device comprising:
a GUI generator capable of processing a GUI including at least one item in three dimensions;
a user selection part to allow a user to select the item; and
a controller to control the GUI generator to process and generate the GUI in two dimensions when a GUI function is selected through the user selection part, and process and generate the item indicated through the user selection part in three dimensions.

2. The electronic device according to claim 1, wherein the controller controls the GUI generator to move the selected item in a virtual axis by a predetermined distance, and process and generate the selected item along with a moving trajectory in three dimensions.

3. The electronic device according to claim 2, wherein the controller controls the GUI generator to move the selected item by a predetermined distance in a (+) direction of the virtual axis.

4. The electronic device according to claim 2, wherein the controller controls the GUI generator to move the selected item by a predetermined distance in a (−) direction of the virtual axis.

5. The electronic device according to claim 2, wherein the controller controls the GUI generator to move the selected item by a predetermined distance in (+) and (−) directions of the virtual axis.

6. The electronic device according to claim 2, wherein the controller controls the GUI generator to process and generate a sub-menu including a plurality of sub-items corresponding to the selected item in two dimensions when the selected item is selected through the user selection part.

7. The electronic device according to claim 2, wherein the controller controls the GUI generator to process and generate a sub-menu including a plurality of sub-items corresponding to the selected item on the same plane as one plane of the item displayed in three dimensions when the selected item is selected through the user selection part.

8. The electronic device according to claim 2, wherein the controller controls the GUI generator to process and generate a sub-menu including a plurality of sub-items corresponding to the selected item on a plane moved by a shorter distance than the predetermined distance along the virtual axis in three dimensions when the selected item is selected through the user selection part.

9. The electronic device according to claim 6, wherein the controller controls the GUI generator to process and generate the sub-item in three dimensions when the sub-item of the sub-menu is selected through the user selection part, and performs a function corresponding to the selected sub-item when the selected sub-item is selected.

10. The electronic device according to claim 9, wherein the controller controls the GUI generator to move the selected sub-item by a predetermined distance in the virtual axis, and process and generate the selected item along with a moving trajectory in three dimensions.

11. The electronic device according to claim 10, wherein the controller controls the GUI generator to further move the selected sub-item by a predetermined distance in the virtual axis than the item generated in the three dimensions.

12. The electronic device according to claim 6, wherein the sub-items of the sub-menu comprises video/audio items to control video and audio modes;
a size item to control a display size of a picture;
a language item to control language;
an input item to control an input video source; and
an auto-program item to search provided channels.

13. The electronic device according to claim 1, wherein the controller controls the GUI generator to change at least one of the brightness, the color and the size of the selected item.

14. The electronic device according to claim 2, wherein the controller controls the GUI generator to change at least one of the brightness, the color and the size of the selected item.

15. A method of controlling an electronic device comprising a GUI generator to generate a GUI including at least one item, the method comprising:
processing and generating the GUI in two dimensions when a GUI function is selected through a user selection part; and
processing and generating the item selected through the user selection part in three dimensions.

16. The method according to claim 15, wherein the processing and generating the selected item in three dimensions comprises moving the selected item in a virtual axis by a predetermined distance, and processing and generating the selected item along with a moving trajectory in three dimensions.

17. The method according to claim 16, further comprising processing and generating a sub-menu including a plurality of sub-items corresponding to the selected item on the same plane as one plane of the item displayed in three dimensions when the selected item is selected through the user selection part.

18. The method according to claim 17, further comprising processing and generating the sub-item in three dimensions when the sub-item is selected on the sub-menu, and performing a function corresponding to the selected sub-item when the selected sub-item is selected.
